(19) United States
(12) Patent Application Publication
(10) Pub. No.: US 2025/0372768 A1
(43) Pub. Date: Dec. 4, 2025

(54) MULTI-LAYERED THERMAL BARRIER ASSEMBLIES FOR TRACTION BATTERY PACKS

(71) Applicant: FORD GLOBAL TECHNOLOGIES, LLC, Dearborn, MI (US)

(72) Inventors: Jie Deng, Novi, MI (US); Liam E. West, Ferndale, MI (US)

(21) Appl. No.: 18/676,933

(22) Filed: May 29, 2024

(51) Int. Cl. H01M 10/658; H01M 10/613; H01M 10/625; H01M 10/653; H01M 10/6551; H01M 50/242

(52) U.S. Cl. CPC H01M 10/658; H01M 10/653; H01M 10/6551; H01M 50/242; H01M 10/613; H01M 10/625; H01M 2220/20

(57) ABSTRACT

A device may include a thermal barrier assembly arranged between a first battery cell and a second battery cell. A device may include a thermal insulating layer of the thermal barrier assembly configured to reduce thermal energy transfer between the first battery cell and the second battery cell. A device may include a first heat spreader fin and a second heat spreader fin each configured to establish a path for directing thermal energy from the first battery cell or the second battery cell away from the thermal insulating layer.

### TECHNICAL FIELD

This disclosure relates generally to traction battery packs, and more particularly to multi-layered thermal barrier assemblies for managing the transfer of thermal energy within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a traction battery pack, including: a thermal barrier assembly arranged between a first battery cell and a second battery cell; a thermal insulating layer of the thermal barrier assembly configured to reduce thermal energy transfer between the first battery cell and the second battery cell; and a first heat spreader fin and a second heat spreader fin each configured to establish a path for directing thermal energy from the first battery cell or the second battery cell away from the thermal insulating layer.

In some aspects, the techniques described herein relate to a traction battery pack, wherein the thermal insulating layer is sandwiched between the first and second heat spreader fins.

In some aspects, the techniques described herein relate to a traction battery pack, wherein the first heat spreader fin interfaces with the first battery cell and the thermal insulating layer.

In some aspects, the techniques described herein relate to a traction battery pack, wherein the second heat spreader fin interfaces with the thermal insulating layer and a second battery cell.

In some aspects, the techniques described herein relate to a traction battery pack, wherein the first and second heat spreader fins each include a body and at least one leg that extends transversely from the body.

In some aspects, the techniques described herein relate to a traction battery pack, wherein the leg of the first heat spreader fin extends beneath a bottom side of the first battery cell such that the first heat spreader fin includes an L-shaped cross-section.

In some aspects, the techniques described herein relate to a traction battery pack, wherein the leg of the second heat spreader fin extends beneath a bottom side of the second battery cell such that the second heat spreader fin includes an L-shaped cross-section.

In some aspects, the techniques described herein relate to a traction battery pack, wherein the leg of the first and second heat spreader fins is a lower leg and each of the first and second heat spreader fins include an upper leg that extends transversely from the body.

In some aspects, the techniques described herein relate to a traction battery pack, wherein the upper leg of the first heat spreader fin extends over a top side of the first battery cell and the lower leg of the first heat spreader extends beneath a bottom side of the first battery cell such that the first heat spreader fin includes a C-shaped cross-section.

In some aspects, the techniques described herein relate to a traction battery pack, wherein the upper leg of the second heat spreader fin extends over a top side of the second battery cell and the lower leg of the second heat spreader extends beneath a bottom side of the second battery cell such that the second heat spreader fin includes a C-shaped cross-section.

In some aspects, the techniques described herein relate to a traction battery pack, wherein the body of the first heat spreader fin is sandwiched between the first battery cell and the thermal insulating layer, and the body of the second heat spreader fin is sandwiched between the thermal insulating layer and the second battery cell.

In some aspects, the techniques described herein relate to a traction battery pack, where the thermal barrier layer is configured to mitigate volume expansion of the first battery cell and the second battery cell.

In some aspects, the techniques described herein relate to a traction battery pack, wherein the first and second heat spreader fins each include a graphite material.

In some aspects, the techniques described herein relate to a traction battery pack, wherein the graphite material is anisotropic in thermal conductivity.

In some aspects, the techniques described herein relate to a traction battery pack, including: a first battery cell and a second battery cell housed within an interior area of an enclosure assembly; and a thermal barrier assembly arranged between the first battery cell and the second battery cell, wherein the thermal barrier assembly includes a first heat spreader fin, a second heat spreader fin, and a thermal insulating layer sandwiched between the first and second heat spreader fins.

In some aspects, the techniques described herein relate to a traction battery pack, wherein the first and second heat spreader fins each include a body and a lower leg that extends transversely from the body, the lower leg of the first heat spreader fin extends beneath a bottom side of the first battery cell, and the lower leg of the second heat spreader fin extends beneath a bottom side of the second battery cell.

In some aspects, the techniques described herein relate to a traction battery pack, further including a thermal interface material interfaced between the thermal barrier assembly and a lower enclosure structure of the enclosure assembly.

In some aspects, the techniques described herein relate to a traction battery pack, wherein the first heat spreader fin includes an upper leg that extends over a top side of the first battery cell, and the second heat spreader fin includes an upper leg that extends over a top side of the second battery cell.

In some aspects, the techniques described herein relate to a traction battery pack, further a thermal interface material interfaced between an upper enclosure structure of the enclosure assembly and the thermal barrier assembly, and another thermal interface material interfaced between the thermal barrier assembly and a lower enclosure structure of the enclosure assembly.

In some aspects, the techniques described herein relate to a traction battery pack, wherein the first and the second heat spreader fins each include a graphite material that is anisotropic in thermal conductivity.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell stack of the traction battery pack of FIG. 2.

FIG. 4 is a closeup view of select portions of the cell stack of FIG. 3.

FIG. 5 illustrates an exemplary thermal barrier assembly arranged between battery cells of the cell stack of FIG. 3.

FIG. 6 illustrates another exemplary thermal barrier assembly arranged between battery cells of the cell stack of FIG. 3.

### DETAILED DESCRIPTION

This disclosure details thermal barrier assemblies for traction battery packs. An exemplary thermal barrier assembly may be configured to inhibit the transfer of thermal energy inside the traction battery pack. The exemplary thermal barrier includes a thermal barrier layer arranged between a pair of heat spreader fins. The thermal barrier layer is configured to provide increased thermal resistance and accommodate battery cell swelling. The heat spreader fins are configured to establish a physical barrier for protecting the thermal insulating layer and provide a path for distributing heat away from the thermal barrier layer. These and other features are discussed in greater detail in the following paragraphs of this detailed description.

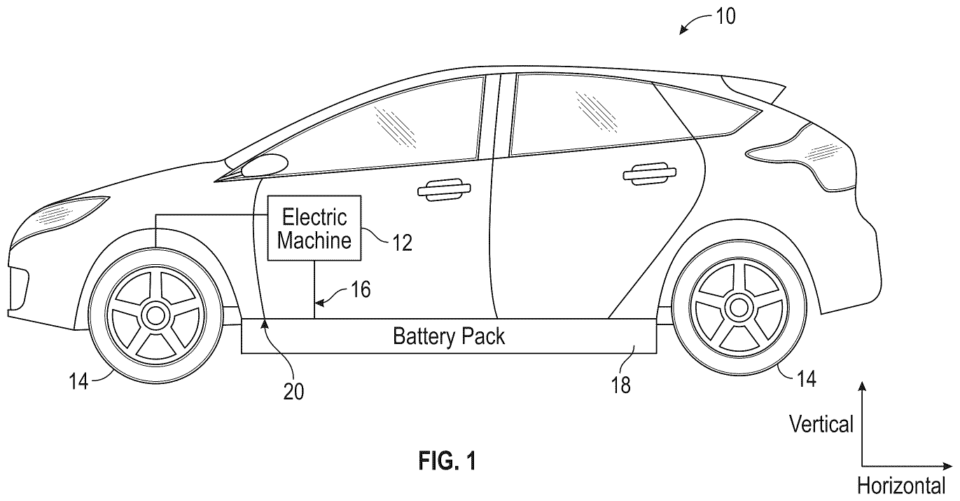

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

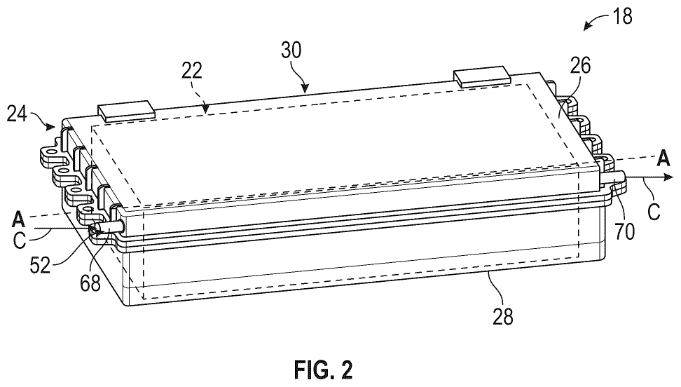

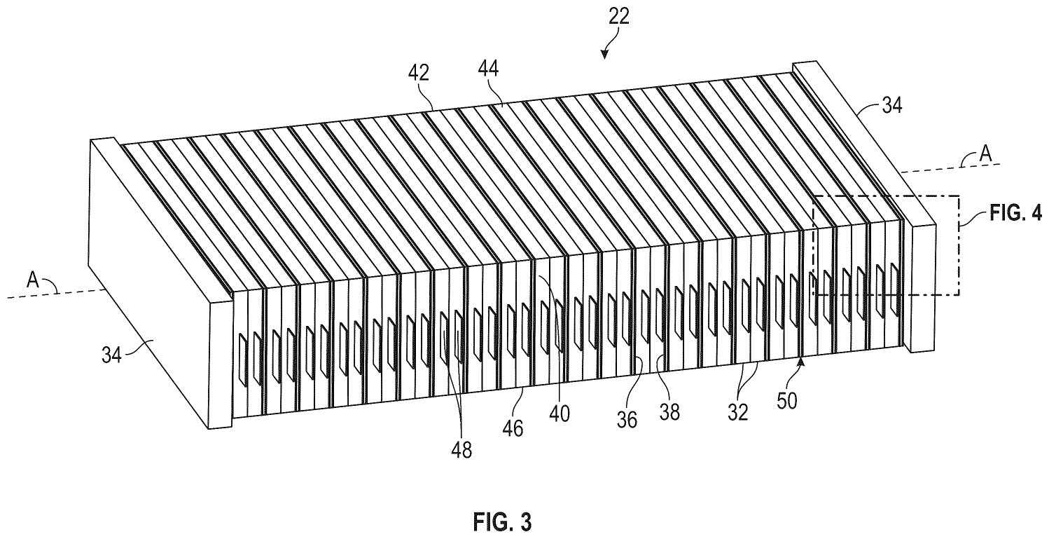

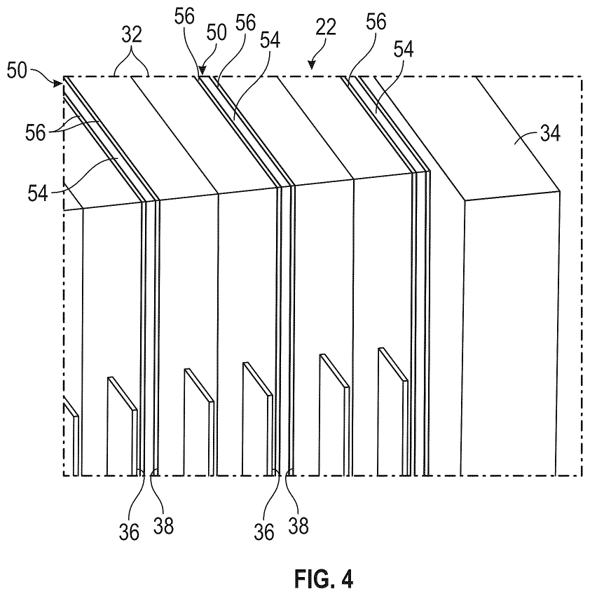

FIGS. 2-4 illustrate additional details associated with the traction battery pack 18 of the electrified vehicle 10. The traction battery pack 18 may include one or more cell stacks 22 (e.g., one shown) housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components (e.g., busbars, control modules and other electronics, etc.) of the traction battery pack 18. The size, shape, and configuration of the enclosure assembly 24 may vary within the scope of this disclosure.

Each cell stack 22 may include a plurality of individual battery cells 32. The battery cells 32 of each cell stack 22 may be stacked together and arranged along a cell stack axis A between opposing end plates 34. The battery cells 32 store and supply electrical power for powering various components in order to support electric propulsion of the electrified vehicle 10. Although a specific number of cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (prismatic, cylindrical, etc.) and/or chemistries (nickel-metal hydride, lead-acid, etc.) could alternatively be utilized within the scope of this disclosure.

Each battery cell 32 may include a first face 36, a second face 38 opposite the first face 36, a first end 40, a second end 42 opposite the first end 40, a top side 44, and a bottom side 46 opposite the top side 44. The first face 36 and the second face 38 establish major side surfaces of the battery cells 32, and the first end 40, the second end 42, the top side 44, and the bottom side 46 establish minor side surfaces of the battery cell 32. The first face 36 and the second face 38 therefore exhibit a greater surface area than any of the first end 40, the second end 42, the top side 44, and the bottom side 46. Various terms such as “top,” “bottom,” “upper,” and “lower” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

A tab terminal 48 may project outwardly from each of the first end 40 and the second end 42 of the battery cells 32. The battery cells 32 may thus be considered to be “side-oriented” within the cell stacks 22. The tab terminals 48 may be connected to busbars (not shown) in order to electrically connect the battery cells 32 of each cell stack 22.

One or more thermal barrier assemblies 50 may be arranged along the respective cell stack axis A of each cell stack 22. In this example, groups of two individual battery cells 32 are separated by thermal barrier assemblies 50 along the cell stack axis A. However, other configurations are contemplated within the scope of this disclosure, and it should be apparent to those having the benefit of this disclosure that the cell stack 22 could include any number of and any arrangement of battery cells 32 and thermal barrier assemblies 50.

The battery cells 32 may be arranged such that the faces 36, 38 of one of the battery cells 32 are in direct contact with one of the faces 36 or 38 of a neighboring battery cell 32 or of a neighboring thermal barrier assembly 50 of the cell stack 22. The battery cells 32 and the thermal barrier assemblies 50 may be held in compression relative to one another within the cell stack 22 to provide the face-to-face arrangement. The compression may be applied by the end plates 34 of the cell stack 22, for example. However, other configurations are contemplated within the scope of this disclosure.

Thermal energy levels of the battery cells 32 of each cell stack 22 can increase as the electrified vehicle 10 is operated. A thermal management system 52 (see FIG. 2) can be employed for managing the thermal energy levels of the battery cells 32, cell stacks 22, and other areas of the traction battery pack 18. The thermal management system 52 may be configured to route a coolant C through the traction battery pack 18 in order to manage the thermal energy within the cell stack 22 by, for example, using the coolant C to take on heat from the cell stack 22.

The thermal management system 52 can deliver the coolant C to the interior area 30 of the traction battery pack 18 through an inlet 68. The coolant C can take on thermal energy from the battery cells 32 of the cell stacks 22 and other components of the traction battery pack 18 for managing the thermal energy levels. The coolant C may exit the traction battery pack 18 through an outlet 70, which may be located at an opposite end of the enclosure assembly 24 from the inlet 68. The coolant C exiting through the outlet 70 can move to a thermal energy exchange device (not shown), such as a heat exchanger, where thermal energy can be transferred from the coolant C to atmosphere. A pump (not shown) can be operated to selectively circulate the coolant C between the traction battery pack 18 and the thermal energy exchange device.

The thermal barrier assemblies 50 may also function as part of the thermal management system 52. Should, for example, a battery thermal event occur in one of the cell stacks 22, the thermal barrier assemblies 50 may reduce or even prevent thermal energy associated with the thermal event from moving from cell-to-cell, compartment-to-compartment, and/or cell stack-to-cell stack, thereby inhibiting the transfer of thermal energy inside the traction battery pack 18.

Each thermal barrier assembly 50 may be configured as a multi-layered structure including a thermal insulating layer 54 arranged between a pair of heat spreader fins 56. In this example, the thermal insulating layer 54 is sandwiched between the heat spreader fins 56.

The thermal insulating layer 54 may be a dual-functional layer that is configured to reduce heat transfer between neighboring cell stacks 22 and accommodate swelling of the battery cells 32 (e.g., mitigate volume expansion of the battery cells 32). Battery swelling can occur due to various reasons, such as overcharging, internal short circuits, or prolonged usage. The thermal insulating layer 54 may include a low-density material (e.g., polyurethane foam, silicone foam, etc.) having high thermal resistance and compression capabilities. However, other materials or combinations of materials are contemplated within the scope of this disclosure.

In an example, the thermal insulating layer 54 may be a continuous layer that uniformly covers the entire surface area of the heat spreader fins 56 which interfaces with the thermal insulating layer 54. In another example, the thermal insulating layer 54 may be a discontinuous layer including separate sections of insulating material that are not in direct contact with one another. These sections may be spaced apart to create gaps therebetween to receive air or coolant such as the coolant C. The continuous and discontinuous layered examples reduce heat transfer between neighboring battery cells 32.

One heat spreader fin 56 may be arranged on each side of the thermal insulating layer 54. The heat spreader fins 56 may therefore flank the thermal insulating layer 54. Each heat spreader fin 56 is sandwiched between a neighboring battery cell 32 of the cell stack 22 and the thermal insulating layer 54. In an example, one of the heat spreader fins 56 interfaces with the first face 36 of a neighboring battery cell 32 and the thermal insulating layer 54, and another of the heat spreader fins 56 interfaces with the second face 38 of a neighboring battery cell 32 and the thermal insulating layer 54.

In an example, a thermal insulating layer 54 may be arranged to interface with each end plate 34, and a heat spreader fin 56 may be arranged between a neighboring battery cell 32 and the thermal insulating layer 54 that interfaces with the end plate 34.

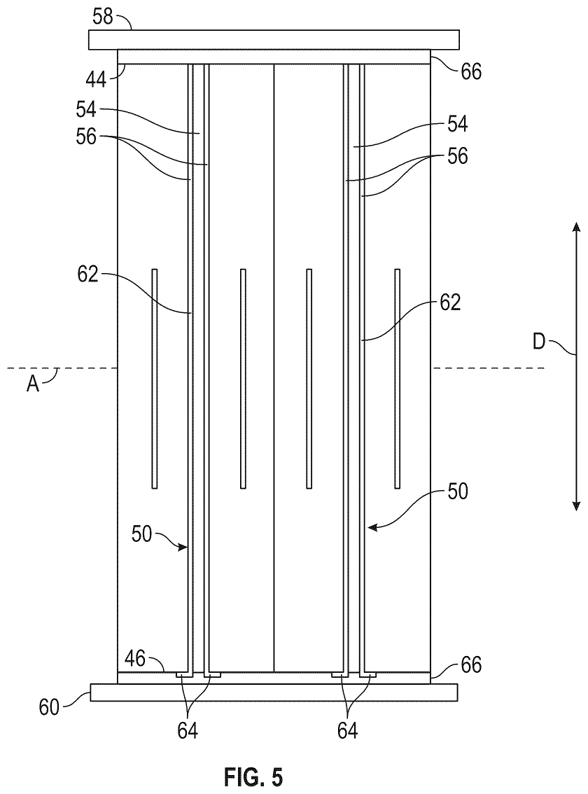

Referring now to FIG. 5, at least one of an upper enclosure structure 58 and a lower enclosure structure 60 may establish a sealed interface with each thermal barrier assembly 50. The upper enclosure structure 58 may be part of the enclosure cover 26 of the enclosure assembly 24 or could be an intermediate structure (e.g., a heat exchanger plate) that is positioned between the thermal barrier assembly 50 and the enclosure cover 26. The lower enclosure structure 60 may be part of a heat exchanger plate (not shown) that is positioned between the thermal barrier assembly 50 and the enclosure tray 28, or could alternatively be part of the enclosure tray 28.

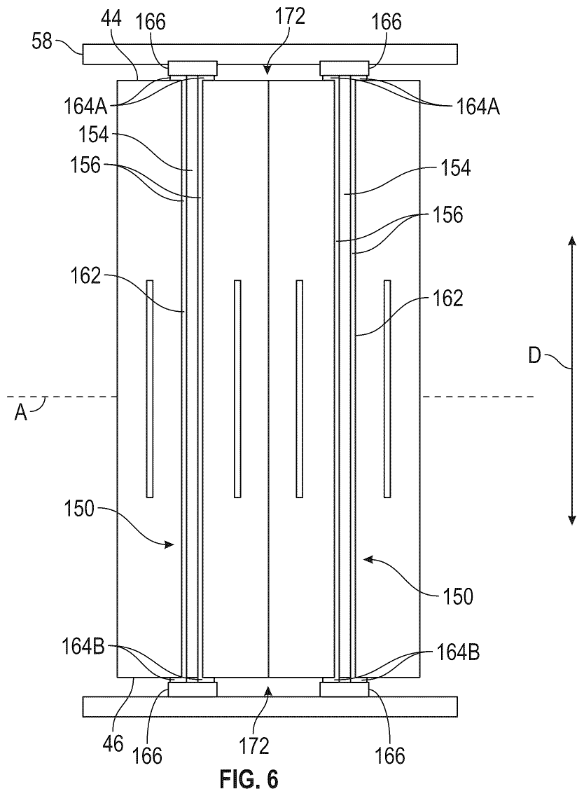

The heat spreader fins 56 may each include a body 62 and a leg 64 that extends transversely (e.g., about perpendicular) from the body 62. The body 62 may be sandwiched axially between a neighboring battery cell 32 and the thermal insulating layer 54. In this example, the body 62 and the leg 64 are configured to provide an L-shaped cross-section of the heat spreader fin 56. However, other shapes are contemplated within the scope of this disclosure (see, e.g., FIG. 6).

The leg 64 of each heat spreader fin 56 may be arranged to extend between the bottom side 46 of a neighboring battery cell 32 and a thermal interface material 66. The leg 64 may be long enough to extend at least partially beneath the bottom side 46 of each respective neighboring battery cell 32. The thermal interface material 66 may be applied between the leg 64 and the lower enclosure structure 60. In one example, the leg 64 is at least partially embedded into the thermal interface material 66. The thermal interface material 66, which could be an electrically insulating and thermally conductive material, may be utilized to secure the thermal barrier assembly 50 to the lower enclosure structure 60. The thermal interface material 66 could have sealing properties for sealing the interface between the thermal barrier assembly 50 and the lower enclosure structure 60. Arranging the heat spreader fins 56 in this manner enables thermal energy to be spread more evenly by establishing a path through the heat spreader fins 56 and then into the lower enclosure structure 60 while eliminating cold side battery cell hot spots. Cold side battery cell temperatures can therefore be kept below battery thermal event trigger temperatures.

In an example, a thermal interface material 66 may be applied between the thermal barrier assembly 50 and the upper enclosure structure 58 to secure the thermal barrier assembly 50 to the upper enclosure structure 58 and facilitate heat transfer therebetween. In another example, a compressible foam may be applied between the thermal barrier assembly 50 and the upper enclosure structure 58. A compressible foam may be desirable where heat from neighboring battery cells 32 is sufficiently dissipated to the lower enclosure structure 60 by the heat spreader fins 56.

The heat spreader fins 56 may be dual-functional heat spreader fins configured to protect the thermal insulating layer 54 from contamination (e.g., particle attack) and provide a path for directing thermal energy away from the thermal insulating layer 54. In an example, the heat spreader fins 56 may be made of a graphite material. The graphite material is resistant to particle attack and maintains a barrier that blocks particles from contacting the thermal insulating layer 54. The graphite material is also anisotropic and thermally conductive, which causes heat from a neighboring battery cell 32 within the cell stack 22 to be conducted or distributed along the heat spreader fins 56 in an in-plane direction D toward the upper enclosure structure 58 and/or the lower enclosure structure 60. Heat distributed toward the upper enclosure structure 58 can be first dissipated into the thermal interface material 66. As discussed above, heat through the leg 64 of each heat spreader fin 56 can be dissipated into the thermal interface material 66 and then into the lower enclosure structure 60.

In an example, the lower enclosure structure 60 may be part of a heat exchanger plate (not shown) that is positioned between the thermal barrier assembly 50 and the enclosure tray 28. The coolant C (see FIG. 2), such as glycol, from the thermal management system 52 can be circulated through the heat exchanger plate in order to thermally manage heat generated by the battery cells 32 and other components of the traction battery pack 18.

In this disclosure, like reference numerals designate like elements where appropriate and reference numerals with the addition of one-hundred or multiples thereof designate modified elements that are understood to incorporate the same features and benefits of the corresponding elements.

FIG. 6 illustrates another exemplary thermal barrier assembly 150 that could be utilized within the traction battery pack 18 to reduce or even prevent thermal energy associated with the thermal event from moving from cell-to-cell, compartment-to-compartment, and/or cell stack-to-cell stack heat transfer between neighboring cell stacks 22. The thermal barrier assembly 50 may include a thermal insulating layer 154 arranged between a pair of heat spreader fins 156. That is, the thermal insulating layer 154 is sandwiched between the heat spreader fins 156.

One heat spreader fin 156 may be arranged on each side of the thermal insulating layer 54. The heat spreader fins 156 may therefore flank the thermal insulating layer 154. Each heat spreader fin 156 is sandwiched between a neighboring battery cell 32 and the thermal insulating layer 154. For example, one of the heat spreader fins 156 interfaces with the first face 36 of a neighboring battery cell 32 and the thermal insulating layer 154, and another of the heat spreader fins 156 interfaces with the second face 38 of a neighboring battery cell 32 and the thermal insulating layer 154.

In this example, the heat spreader fins 156 may each include a body 162, a first leg 164A, and a second leg 164B. The first leg 164A and the second leg 164B of each heat spreader fin 156 extend transversely (e.g., about perpendicular) from the body 162. The body 162 may be sandwiched axially between a neighboring battery cell 32 of a neighboring cell stack 22 and the thermal insulating layer 154.

The body 162 and the first and second legs 164A, 164B are configured to provide a C-shaped cross-section of the heat spreader fin 156. The first leg 164A of each heat spreader fin 156 may be an upper leg arranged to extend between the top side 44 of a neighboring battery cell 32 and the upper enclosure structure 58. The second leg 164B of each heat spreader fin 156 may be a lower leg arranged to extend between the bottom side 46 of a neighboring battery cell 32 and the lower enclosure structure 60. The first leg 164A may be long enough to extend over the top side 44 of each respective neighboring battery cell 32, and the second leg 164B may be long enough to extend beneath the bottom side 46 of each respective neighboring battery cell 32. The first leg 164A and the second leg 164B of each heat spreader fin 156 together provide increased surface area to dissipate heat. A thermal interface material 166 may be applied between the first legs 164A of each heat spreader fin 156 and the upper enclosure structure 58 to facilitate heat transfer therebetween. Another thermal interface material 166 may be applied between the second legs 164B of each heat spreader fin 156 and the lower enclosure structure 60 to facilitate heat transfer therebetween. The thermal interface material 166 in this example may be a discontinuous layer including separate sections of insulating material that are not in direct contact with one another. A space 172 is established between each section of thermal interface material 166 to receive coolant flow.

Arranging the heat spreader fins 156 in this manner provides immersion thermal management in which portions of the traction battery pack 18, here at least portions of the battery cells 32, are immersed in the coolant C. Thermal energy can transfer between the coolant C and the battery cells 32 as the coolant C flows over and/or around the battery cells 32 through the spaces 172. The coolant C can help manage thermal energy levels of the battery cells 32 as well as other components of the traction battery pack 18.

The coolant C can fill one or more open areas within the interior area 30 (including the spaces 172) such that the battery cells 32 are immersed in, and directly contacted by, the coolant C within the traction battery pack 18. The coolant C in this example may be a dielectric fluid or another type of non-conductive fluid (e.g., oil) that is designed for immersion cooling the battery cells 32. However, other non-conductive fluids may also be suitable, and the actual chemical make-up and design characteristics (e.g., dielectric constant, maximum breakdown strength, boiling point, etc.) may vary depending on the environment the traction battery pack 18 is to be employed within.

The exemplary thermal barrier assemblies of this disclosure are dual functional thermal barrier assemblies. The exemplary thermal barrier layer is configured to provide increased thermal resistance and accommodate battery cell swelling. The exemplary heat spreader fins are configured to provide increased thermal resistance and to protect the thermal insulating layer from contamination. The proposed thermal barrier designs can be used for both immersion cooling and non-immersion cooling thermal arrangements, thereby providing increased utility compared to prior barrier systems.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a thermal barrier assembly arranged between a first battery cell and a second battery cell;
a thermal insulating layer of the thermal barrier assembly configured to reduce thermal energy transfer between the first battery cell and the second battery cell; and
a first heat spreader fin and a second heat spreader fin each configured to establish a path for directing thermal energy from the first battery cell or the second battery cell away from the thermal insulating layer.

2. The traction battery pack as recited in claim 1, wherein the thermal insulating layer is sandwiched between the first and second heat spreader fins.

3. The traction battery pack as recited in claim 1, wherein the first heat spreader fin interfaces with the first battery cell and the thermal insulating layer.

4. The traction battery pack as recited in claim 1, wherein the second heat spreader fin interfaces with the thermal insulating layer and a second battery cell.

5. The traction battery pack as recited in claim 1, wherein the first and second heat spreader fins each include a body and at least one leg that extends transversely from the body.

6. The traction battery pack as recited in claim 5, wherein the leg of the first heat spreader fin extends beneath a bottom side of the first battery cell such that the first heat spreader fin includes an L-shaped cross-section.

7. The traction battery pack as recited in claim 5, wherein the leg of the second heat spreader fin extends beneath a bottom side of the second battery cell such that the second heat spreader fin includes an L-shaped cross-section.

8. The traction battery pack as recited in claim 5, wherein the leg of the first and second heat spreader fins is a lower leg and each of the first and second heat spreader fins include an upper leg that extends transversely from the body.

9. The traction battery pack as recited in claim 8, wherein the upper leg of the first heat spreader fin extends over a top side of the first battery cell and the lower leg of the first heat spreader extends beneath a bottom side of the first battery cell such that the first heat spreader fin includes a C-shaped cross-section.

10. The traction battery pack as recited in claim 8, wherein the upper leg of the second heat spreader fin extends over a top side of the second battery cell and the lower leg of the second heat spreader extends beneath a bottom side of the second battery cell such that the second heat spreader fin includes a C-shaped cross-section.

11. The traction battery pack as recited in claim 5, wherein the body of the first heat spreader fin is sandwiched between the first battery cell and the thermal insulating layer, and the body of the second heat spreader fin is sandwiched between the thermal insulating layer and the second battery cell.

12. The traction battery pack as recited in claim 1, where the thermal barrier layer is configured to mitigate volume expansion of the first battery cell and the second battery cell.

13. The traction battery pack as recited in claim 1, wherein the first and second heat spreader fins each include a graphite material.

14. The traction battery pack as recited in claim 13, wherein the graphite material is anisotropic in thermal conductivity.

15. A traction battery pack, comprising:
a first battery cell and a second battery cell housed within an interior area of an enclosure assembly; and
a thermal barrier assembly arranged between the first battery cell and the second battery cell,
wherein the thermal barrier assembly includes a first heat spreader fin, a second heat spreader fin, and a thermal insulating layer sandwiched between the first and second heat spreader fins.

16. The traction battery pack as recited in claim 15, wherein the first and second heat spreader fins each include a body and a lower leg that extends transversely from the body, the lower leg of the first heat spreader fin extends beneath a bottom side of the first battery cell, and the lower leg of the second heat spreader fin extends beneath a bottom side of the second battery cell.

17. The traction battery pack as recited in claim 16, further comprising a thermal interface material interfaced between the thermal barrier assembly and a lower enclosure structure of the enclosure assembly.

18. The traction battery pack as recited in claim 16, wherein the first heat spreader fin includes an upper leg that extends over a top side of the first battery cell, and the second heat spreader fin includes an upper leg that extends over a top side of the second battery cell.

19. The traction battery pack as recited in claim 18, further a thermal interface material interfaced between an upper enclosure structure of the enclosure assembly and the thermal barrier assembly, and another thermal interface material interfaced between the thermal barrier assembly and a lower enclosure structure of the enclosure assembly.

20. The traction battery pack as recited in claim 15, wherein the first and the second heat spreader fins each include a graphite material that is anisotropic in thermal conductivity.
